(19) United States
(12) Patent Application Publication
(10) Pub. No.: US 2007/0246631 A1
(43) Pub. Date: Oct. 25, 2007

(54) Automatic leveling suspension system for luminaires

(75) Inventors: Raymond A. Brown, Spokane Valley, WA (US); Gary W. Brondt, Cheney, WA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hubbell Incorporated

(21) Appl. No.: 11/404,100

(22) Filed: Apr. 14, 2006

(51) Int. Cl. B42F 13/00

(52) U.S. Cl. 248/343

(57) ABSTRACT

A mechanism and method for automatically leveling an assembly, such as a lighting fixture, suspended from a cable having a loop, the assembly having a support member. The mechanism comprises a hanger having an opening for receiving the support member of the assembly therein. The hanger includes a plurality of sides and at least one interior downwardly facing surface for engaging the cable loop through the hanger. The hanger is inserted through a tongue on the suspension assembly and the cable loop is inserted into the hanger and engages the interior downwardly facing surface, thereby automatically leveling and suspending the assembly from the ceiling.

### FIELD OF THE INVENTION

The present invention relates to a leveling hanger for suspending a lighting fixture. More specifically, the invention relates to a suspension system for automatically leveling a lighting fixture suspended from cables coupled to the ceiling of a building. Still more particularly, the present invention includes a hanger having an upwardly facing surface engaging a support member on the fixture and a downwardly facing surface engaging the loop of a suspension cable, the hanger being substantially perpendicular to the fixture and fixedly receiving the loop in the center of the hanger to maintain the fixture in a level configuration.

### BACKGROUND OF THE INVENTION

Conventional lighting fixtures for retail and industrial applications are often installed or mounted by being suspended from a ceiling. Typically, fixture ends are removed allowing access to cables extending through the housing top wall, and the cable ends are fastened to the housing. Subsequent to assembling the cables with each end of the lighting fixture, the fixture ends are reattached and the cables are mounted to the ceiling, thereby suspending the fixture. However, this is a time consuming process. Recent improvements have used suspension cables coupled directly to the housing, and the suspension cables include loops for engaging the lighting fixture. However, the installation process may require additional adjustments by hand because the sides of the cable loop can hang up on the sides of the sheet metal tabs receiving the loops and hold the fixture at an angle rather than horizontal, i.e., level to the ground.

Examples of suspended lighting fixtures include U.S. patent application No. 2004/0218393 to Brondt et al., U.S. Pat. No. 6,530,674 to Grierson et al., U.S. Pat. No. 5,658,066 to Hirsch, and U.S. Pat. No. 4,726,781 to Bernhart et al., the disclosures of each of which are hereby incorporated herein by reference.

A need exists for an improved leveling suspension assembly for a lighting fixture.

### SUMMARY OF THE INVENTION

Accordingly, an object of the present invention is to provide a lighting fixture that is easily and quickly suspended in a level configuration from a ceiling or beam.

Another object of the present invention is to provide a lighting fixture with a suspension assembly that engages a hanger subsequent to suspending cables from a support, such as a ceiling.

Yet another object of the present invention is to provide a lighting fixture that may be suspended with a leveling mechanism without the need for modification of the fixture.

Still another object of the present invention is to provide a lighting fixture that may be suspended with a leveling mechanism such as a hanger that balances the lighting fixture through the centerline of the suspension cable.

The foregoing objects are attained by providing a mechanism for automatically leveling an assembly suspended from a cable having a loop, the assembly having a support member, the mechanism comprising a hanger having an opening for receiving the support member of the assembly therein, the hanger including a plurality of sides, and at least one interior downwardly facing surface for engaging the cable loop through the hanger.

The foregoing objects are also attained by providing a mechanism for automatically leveling a light fixture suspended from a cable having a loop, the light fixture having a support member with a downwardly facing surface, the mechanism comprising a hanger having a plurality of sides, a first of the plurality of sides for engaging the downwardly facing surface on the support member, the hanger having a downwardly facing, curved portion for receiving the loop of the cable therein and resisting relative movement therebetween.

Other objects, advantages and salient features of the invention will become apparent from the following detailed description, which, taken in conjunction with annexed drawings, discloses a preferred embodiment of the present invention.

### BRIEF DESCRIPTION OF THE DRAWINGS

Referring to the drawings which form a part of this disclosure:

FIG. 1 is a perspective view of a lighting fixture and a suspension system in accordance with an embodiment of the present invention, showing the lighting fixture suspended from a support;

FIG. 2 is an enlarged partial perspective view of the lighting fixture of FIG. 1, showing a support member of the suspension system engaged by an automatic leveling five-sided hanger;

FIG. 3 is a side elevational view in cross section of one embodiment of the hanger taken along line 3-3 of FIG. 2;

FIG. 4 is a top plan view of the hanger shown in FIGS. 1-3, with the cable loop shown in cross section;

FIG. 5 is a side elevational view in cross section of the hanger shown in FIGS. 1-4 taken along line 5-5 in FIG. 3;

FIG. 6 is a side elevational view in cross section of a second embodiment of the hanger showing a triangular hanger suspending the lighting fixture;

FIG. 7 is a top plan view of the hanger shown in FIG. 6, with the cable loop shown in cross section;

FIG. 8 is a side elevational view in cross section of the hanger shown in FIGS. 6-7 taken along line 8-8 in FIG. 6;

FIG. 9 is a side elevational view in cross section of a third embodiment of a hanger having a U-shaped opening and formed from flat sheet metal;

FIG. 10 is a side elevational view in cross section of a fourth embodiment of a hanger having a T-shape and formed from flat sheet metal;

FIG. 11 is a side elevational view in cross section of a fifth embodiment of a hanger having a T-shape and formed from flat sheet metal;

FIG. 12 is a side elevational view in cross section of a sixth embodiment of a hanger having a T-shape and formed from flat sheet metal;

FIG. 13 is a side elevational view of a seventh embodiment of a hanger having an S-shape and formed from flat sheet metal; and

FIG. 14 is a side elevational view in cross section of the hanger in FIG. 13 after being folded in half and suspended in the lighting fixture and coupled to the cable loop.

### DETAILED DESCRIPTION OF THE INVENTION

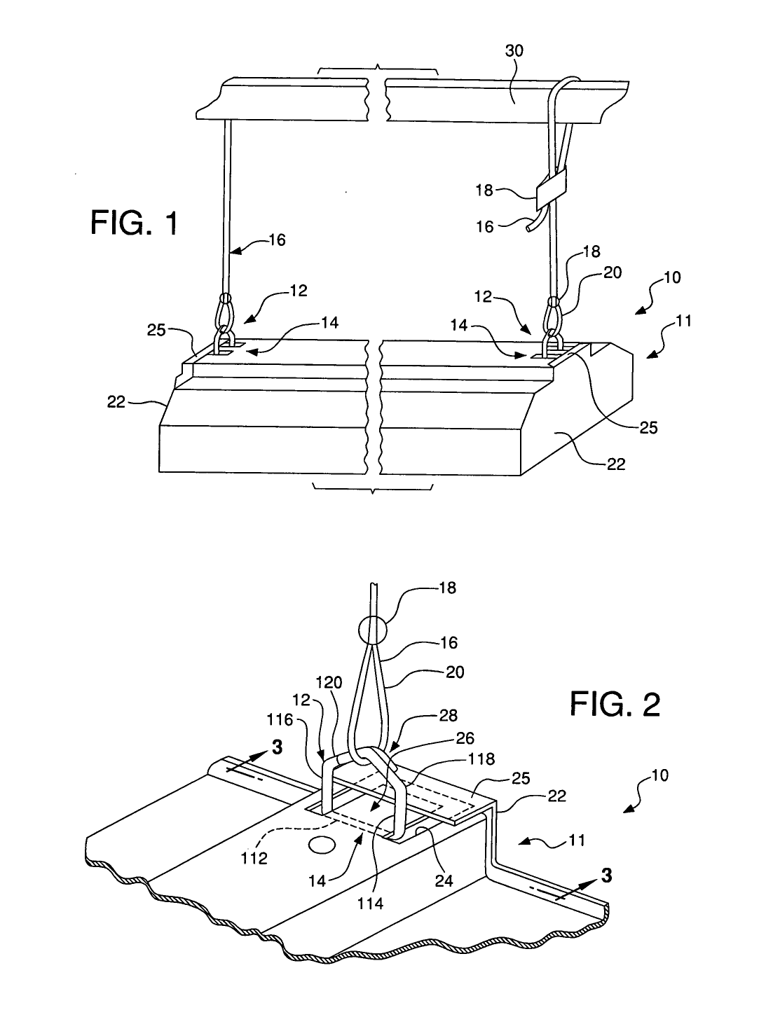

Referring to FIGS. 1-5, a suspension assembly 10 for a lighting fixture 11, in accordance with the present invention, includes a hanger 12 and a support member 14 that extends outwardly and horizontally towards the ends 22 of the lighting fixture 11. The support members or tongues 14 are planar and located on the upper planar surface of the lighting fixture 11 and are positioned parallel to the bottom of the lighting fixture 11. Tongues 14 are substantially rectangular in shape and are surrounded by a U-shaped recess 24 at the three sides closest to the ends 22 of the lighting fixture 11 with a cover plate 25 extending horizontally and inwardly from each of the ends 22 and over parts of the tongue 14 and recess 24. The tongues 14 extend along the horizontal center of gravity axis of the fixture.

As illustrated in FIG. 1, the lighting fixture 11 is suspended from the ceiling with cables 16, looped around a joist 30 at one end of cable 16 and attached to the lighting fixture 11 at the opposite end of cable 16. The cables 16 are typically formed of aircraft cable with multiple strands and secured with knots or clamping mechanisms 18. Towards the lower end of cable 16, each cable 16 forms a substantially oval loop 20 to receive a hooking connecting mechanism such as hanger 12 that secures the cable 16 to the lighting fixture 11.

The hanger 12, as seen in FIGS. 1-5, includes a plurality of sides and has an opening 26 defined by its sides for receiving the tongue 14 of the lighting fixture 11. The hanger 12 further includes at least one interior downwardly facing surface or curved portion 28 for engaging the cable loop 20 through the hanger 12.

Hanger 12 as seen in FIGS. 1-5 is five-sided and is formed of a one-piece, bent and flexible metallic wire having a substantially straight bottom side 112, two substantially straight sides 114 and 116 substantially perpendicular to bottom side 112, and two curved or bent upper sides 118 and 120, which extend respectively from sides 114 and 116 and partially overlap one another over about one-half their lengths. Sides 118 and 120 each have a substantially 90 degree curve or bend therein, which align and form the downwardly facing surface or curved or bent portion 28 in the hanger 12 to receive the bottom of the loop therein and to prevent and/or resist relative movement of the loop and the hanger along the hanger after such reception therein.

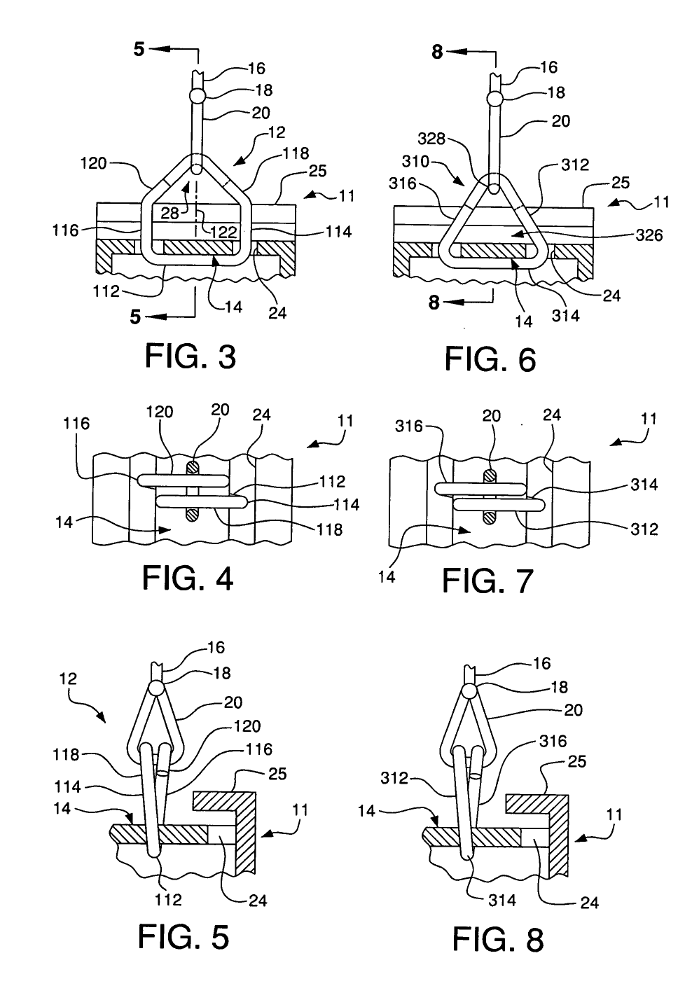

As seen in FIG. 3, the hanger 12 has a substantially vertical central axis 122 which is substantially coincident with the center of gravity of the hanger and with the cable itself, as well as the center of curved portion 28. The loop 20 substantially defines a vertical plane that receives the vertical central axis 122 therein.

This structure aids in allowing the hanger 12 to automatically level the lighting fixture 11 once they are connected since the loop 20 is substantially fixedly received in the curved portion 28 and tends not to move out of that curved portion. The automatic leveling, as noted in more detail hereinafter, is also aided by the engagement of the straight or planar top edge of bottom side 112 with the planar bottom surface of the tongue 14 as best seen in FIGS. 1-5. To connect the hanger 12 to fixture 11, the bottom side 112 of the hanger is maneuvered between the top of the tongue 14 and the bottom of cover plate 25 and is then looped over the end of the tongue 14 with the sides 114 and 116 being received in recess 24. The hanger 12 is then pulled away from the end 22 of the fixture into the vertical position shown in FIGS. 1-5.

As seen in FIGS. 4-5, curved sides 118 and 120 are separated slightly, advantageously by about 1/16 inch at the largest extend, so the loop 20 can then be maneuvered through that separation, and then pivoted by 90 degrees to easily couple the loop 20 to the hanger 12. In the vertical direction, the plane substantially containing the bottom side 112 is at an angle of about 10 degrees to the plane substantially containing side 114 and upper side 118 and to the plane substantially containing side 116 and upper side 120.

The hanger 12 comprises at least one horizontal bottom side 112 positioned below tongue 14 in the recess 24 of the lighting fixture 11 as seen in FIGS. 1-5. This bottom side 112 is substantially parallel to tongue 14. The bottom side 112 supports the vertical and substantially perpendicular orientation of hanger 12 relative to the lighting fixture because the bottom side 112 receives and resists the downward force of gravity acting on the lighting fixture 11. Two of the other sides 118 and 120 of hanger 12 closest to the cable 16 engage the cable loop 20, passing through each side of the loop 20 and coupling the hanger 12 to the loop 20.

The upper sides 118 and 120, nearest the cable loop 20, overlap each other once the loop has been passed through them, thus attaching hanger 12 to cable 16 and thereby securing the lighting fixture 11.

The hanger 12 automatically levels the lighting fixture 11 because of its mechanical orientation with respect to the lighting fixture 11 and the cable loop 20. When the center of cable loop 20 is positioned in the center 28 of hanger 12, at the apex of the overlapping sides, then tongue 14 and lighting fixture 11 are automatically leveled and are horizontally oriented because the center of gravity of the fixture, center of cable loop 20, and the center of hanger 12 are aligned. The gravitational forces acting upon lighting fixture 10 are transferred to cable 16 via hanger 12, pulling the structures in a downward direction. The vertical centerline of the cable and hanger are substantially coincident with the center of gravity of the lighting fixture, so there are no forces present to tilt the fixture out of a horizontal orientation. The engagement of the curved portion 28 of hanger 12 to cable loop 20 resists relative movement therebetween and forces the loop to be in the center of the hanger, and the positioning of planar tongue 14 over the planar bottom side 112 of hanger 12 resists any tilting between the hanger and the tongue. Thus, the fixture is automatically suspended in a level position.

The hanger 12 positioned at the center of cable loop 20 creates a downward force acting upon the loop thereby suspending the lighting fixture 11. The tightness of loop 20 is an instrumental variable in centering hanger 12 such that hanger 12 is centered on the middle vertical line passing through loop 20. A tighter loop 20 will yield a closer-centered hanger 12 with respect to the loop 20. When hanger 12 is suspended at both ends of lighting fixture 11 and directly above tongues 14, hanger 12 is aligned with the center of gravity in the suspension assembly 10.

In another embodiment, as illustrated in FIGS. 6-8, hanger 310 comprises three sides 312, 314, and 316 that form an isosceles triangle in elevational view, with sides 312 and 316 overlapping one another and being curved at the apex of the hanger. Of the three sides 312, 314, and 316, two sides 312, 316 form the interior downwardly facing surface or curved portion 328. These two sides 312, 316 are angled at substantially sixty degrees to the horizontal side 314 and to one another. Sides 312 and 316 of hanger 310 engage the cable loop 20 at the apex or peak 328 of the triangle by each side 312, 316 passing through the loop 20. The sixty degree orientation of the substantially triangular hanger 310 combined with the suspension from engaging tongue 14 and loop 20 levels the lighting fixture 11 in a fashion similar to that regarding hanger 12 describe above.

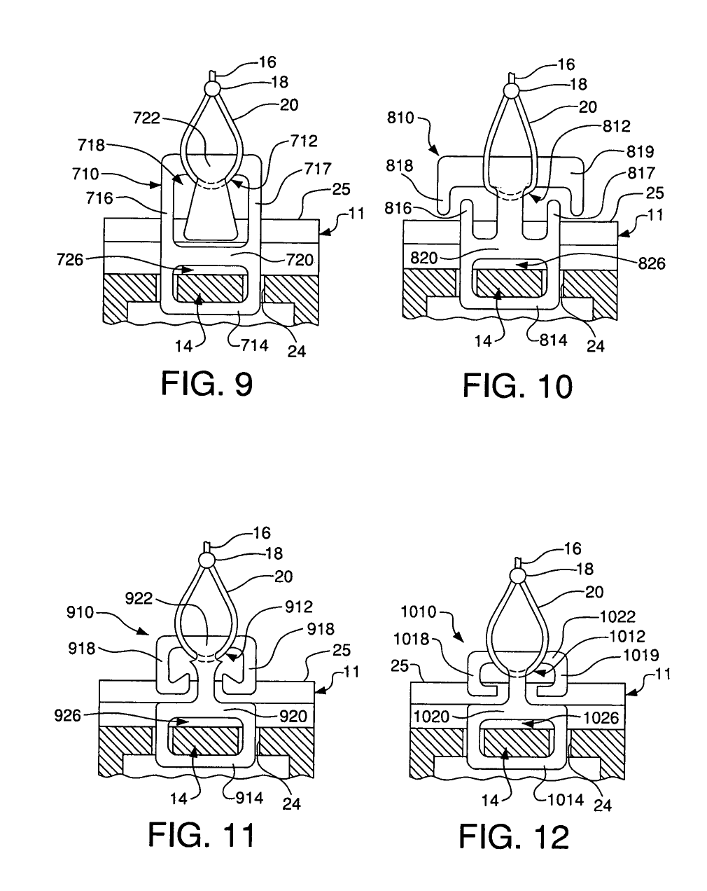

In other embodiments, illustrated in FIGS. 9-13, hangers 710, 810, 910, 1010, and 1110 are constructed from a bendable material with a planar surface, such as flat sheet metal.

In FIG. 9, hanger 710 is a substantially square hanger formed from flat sheet metal having a U-shaped opening 718 at its upper end, between parallel upper and lower sides 722 and 720. The upper parts of U-shaped opening 718 form the downwardly facing surface 712. An opening 726 for receiving the tongue 14 is situated between two sides 716 and 717 that are in a plane parallel to the plane containing loop 20 and form the outer surface of hanger 710. Once opening 726 receives tongue 14, loop 20 of cable 16 is maneuvered through opening 718 and hooks around and engages downwardly facing surface 712. Loop 20 fits tightly in opening 718 at the upper end of hanger 710, such that hanger 710 is suspended through the vertical centerline of loop 20 and the fixture 11 is automatically oriented in a level position. In this embodiment, hanger 710 comprises two sides 720, 714 that are parallel to the top surface of hanger 710 and form opening 726 for receiving tongue 14.

In FIG. 10, hanger 810 is a substantially T-shaped hanger formed from flat sheet metal having a square bottom formed by sides 816, 817, 814, and 820. Opening 826 receives tongue 14 and then hanger 810 is positioned upright for receiving cable loop 20. The upper portion of hanger 810 is a substantially T-shaped member having two sides 818 and 819 perpendicular to the downwardly facing surface 812. The upper parts of T-shaped hanger 810 form downwardly facing surface 812. Parallel sides 816 and 817 are adjacent and perpendicular to side 820, but are situated between downwardly facing surface 812 and sides 818 and 819, such that sections 812, 816, and 818 are in parallel planes. Sides 818 overlap sides 816. Cable loop 20 fits tightly around downwardly facing surface 812, towards the upper end of hanger 810.

In yet another embodiment, illustrated in FIG. 11, hanger 910 is a substantially T-shaped hanger formed from flat sheet metal having substantially hook-shaped projections 918 that point towards an interior downwardly facing surface 912. Again, like the previously described embodiments, hanger 910 has a square opening 926 for receiving tongue 14 after maneuvering hanger 910 through lighting fixture 11. Once hanger 910 is slipped around tongue 14, cable loop 20 is looped around upper portion of substantially T-shaped hanger 910, through the opening formed by substantially hook-shaped projections 918 adjacent to side 922.

In a further embodiment, illustrated in FIG. 12, hanger 1010 is a substantially T-shaped hanger formed from flat sheet metal having projections 1018 and 1019 adjacent side 1022. Projections 1018 and 1019 are adjacent upper portion 1022 and point inward and below interior downwardly facing surface 1012. Opening 1026 for receiving tongue 14 is formed by parallel sections 1020, 1014 and side portions extending between sections 1020, 1014. Once hanger 1010 is slipped around tongue 14, cable loop 20 is maneuvered around projections 1018 and 1019 and through the opening formed by projections 1018 and 1019 and engage interior downwardly facing surface 1012.

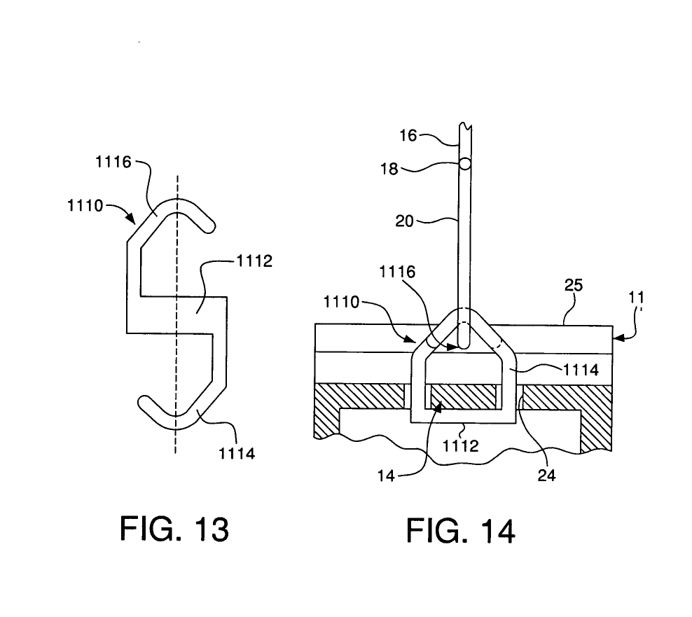

In another embodiment, illustrated in FIGS. 13-14, hanger 1110 is a substantially S-shaped hanger in its unfolded configuration and is formed from bendable flat sheet metal with the lower portion 1114 pivoted vertically towards upper portion 1116 to form a five-sided figure with a downwardly facing surface 1116, shown in FIG. 14. When hanger 1110 is attached to lighting fixture 11, horizontal side 1112 attaches to tongue 14. Referring to FIG. 14, upper portion 1116 and lower portion 1114 overlap each other after passing through cable loop 20 to form substantially the same shape as the embodiment of hanger 12, as illustrated in FIGS. 1-5.

While advantageous embodiments have been chosen to illustrate the invention, it will be understood by those skilled in the art that various changes and modifications can be made therein without departing from the scope of the invention as defined in the appended claims.

What is claimed is:

1. A mechanism for automatically leveling an assembly suspended from a cable having a loop, the assembly having a support member, the mechanism comprising:
a hanger having an opening for receiving the support member of the assembly therein,
said hanger including a plurality of sides, and at least one interior downwardly facing surface for engaging the cable loop through said hanger.

2. The mechanism of claim 1, wherein
said at least one interior surface has a curved portion for receiving the cable loop and resisting relative movement between the cable loop and said hanger.

3. The mechanism of claim 2, wherein
one of said plurality of sides of said hanger is adapted to engage the support member and to resist relative pivoting movement between the support member and said hanger.

4. The mechanism of claim 3, wherein
said one of said plurality of sides of said hanger is substantially straight and is adapted to engage a substantially planar surface on the support member.

5. The mechanism of claim 1, wherein
said hanger has a substantially vertical central axis which is substantially coincident with the center of gravity of said hanger.

6. The mechanism of claim 1, wherein
said hanger has a substantially vertical central axis which is substantially coincident with the cable.

7. The mechanism of claim 1, wherein
said hanger has a substantially vertical central axis and the loop substantially defines a plane receiving said vertical central axis therein.

8. The mechanism of claim 1, wherein
said suspension assembly is a lighting fixture.

9. The mechanism of claim 1, wherein
said hanger comprises a bendable material.

10. The mechanism of claim 9, wherein
said bendable material is a metallic wire.

11. The mechanism of claim 1, wherein
said plurality of sides includes a first and a second part which overlap each other.

12. The mechanism of claim 1, wherein
said hanger includes at least five sides.

13. The mechanism of claim 12, wherein
two of said five sides form said interior surface and are angled at substantially 90 degrees.

14. The mechanism of claim 1, wherein
said hanger includes three sides.

15. The mechanism of claim 14, wherein
two of said three sides form said interior surface and are angled at substantially 60 degrees.

16. The mechanism of claim 1 wherein
said hanger comprises flat sheet metal.

17. The mechanism of claim 1 wherein
said hanger is substantially S-shaped in an unfolded configuration.

18. The mechanism of claim 1 wherein
said hanger has a substantially U-shaped opening, the upper parts of said U-shaped opening forming said interior surface.

19. The mechanism of claim 1, wherein
said hanger has a substantially T-shaped opening, the upper parts of said T-shaped opening forming said interior surface.

20. The mechanism of claim 19, wherein
said T-shaped opening is further defined by at least two substantially hook-shaped projections.

21. A mechanism for automatically leveling a light fixture suspended from a cable having a loop, the light fixture having a support member with a downwardly facing surface, the mechanism comprising:
a hanger having a plurality of sides, a first of said plurality of sides for engaging the downwardly facing surface on the support member,
said hanger having a downwardly facing curved portion for receiving the loop of said cable therein and resisting relative movement therebetween.

22. The mechanism of claim 21, wherein
said hanger includes five sides.

23. The mechanism of claim 21, wherein
said hanger includes three sides.

24. The mechanism of claim 21, wherein
said hanger is substantially S-shaped in an unfolded configuration.

25. The mechanism of claim 21, wherein
said hanger has a substantially U-shaped opening.

26. The mechanism of claim 21, wherein
said hanger has a substantially T-shaped opening.

27. A mechanism for automatically leveling an assembly suspended from a cable having a loop, the assembly having a support member, the mechanism comprising:
a hanger having an upwardly facing surface engaging the support member and resisting relative angular movement therebetween, and having a downwardly facing surface engaging the loop of the cable and resisting relative translational movement therebetween.

28. The mechanism of claim 27, wherein
said downwardly facing surface is substantially curved.

29. The mechanism of claim 28, wherein
said upwardly facing surface is substantially planar.

30. The mechanism of claim 27, wherein
said upwardly facing surface is substantially planar.

31. The mechanism of claim 27, wherein
said downwardly facing surface includes two spaced apart surfaces with a downwardly extending member therebetween.

32. The mechanism of claim 27, wherein
said downwardly facing surface includes an angle of about 90 degrees.

33. The mechanism of claim 27, wherein
said downwardly facing surface includes an angle of about 60 degrees.
